(19) United States
(12) Patent Application Publication
(10) Pub. No.: US 2006/0165057 A1
(43) Pub. Date: Jul. 27, 2006

(54) Presenting dialup access numbers status information using an automated voice response system

(75) Inventors: Jonathan Paden, Austin, TX (US); Bobby Sams, Austin, TX (US); Dennis Collins, Hopewell Junction, NY (US); Jon Harris, Little Elm, TX (US)

Correspondence Address: AKERMAN SENTERFITT, P.O. BOX 3188, WEST PALM BEACH, FL, 33402-3188, US

(73) Assignee: SBC Knowledge Ventures, L.P., Reno, NV (US)

(21) Appl. No.: 10/980,994

(22) Filed: Nov. 4, 2004

(51) Int. Cl. H04L 12/66

(52) U.S. Cl. 370/352

(57) ABSTRACT

A method for an automated voice response system to present access numbers status information to dial-up Internet users. The automated voice response system can perform the step of establishing a telephony communication with a party responsive to a received telephone call from the party. An access number can be received from the party. At least one data store can be queried for entries associated the access number. Responsive to this query, a current status for the access number can be determined. An indication of the status can be presented to the party across the telephone communication.

### BACKGROUND

1. Field of the Invention

The present invention relates to the field of dial-up networking and, more particularly, to automatically presenting access number status information using a voice response system.

2. Description of the Related Art

Dial-up Internet users access the Internet by establishing a communication link between their home computer and a computing device of an Internet Service Provider (ISP). The communication link occurs across a phone line and is established when the user contacts the ISP computer device via one or more access telephone numbers. Generally, the user will be able to select one of many access number local to the user so that telephone usage charges are minimized.

It is not uncommon for dial-up users to experience problems when connecting to the Internet via an access number. One typical connectivity problem is an end user problem, meaning that the user is experiencing problems with their home computer, which results in the user being unable to establish a connection with the ISP computing device. Another reason that dial-up users are unable to connect to the Internet is that the access number that the user dialed is temporarily malfunctioning.

Problems with an access number will affect a large user population at approximately the same time. A significant portion of these affected users will attempt to contact the customer support center, thereby overloading the call handling capabilities of the customer support center. When the call handling capabilities of the customer support center is overloaded, customers can experience extremely long wait times, which can exasperate callers who may already be frustrated by their inability to access the Internet.

Currently, customer support centers do no provide an automated means through which customers can ascertain the status of dialup access numbers. Such a capability would allow a customer to determine whether an experienced problem was due to the customer's equipment or to a problem with the Internet Service Provider. Accordingly, such a capability, currently lacking in conventional systems, could decrease the call volume handled by live customer service agents while providing enhanced customer service.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating an automated system for automatically presenting dialup access number status information in accordance with one embodiment of the invention.

FIG. 2 is a menu structure for providing dialup access number status information in accordance with one embodiment of the invention.

FIG. 3 is a flow chart illustrating a method for providing dialup access number status information in accordance with one embodiment of the invention.

### DETAILED DESCRIPTION OF THE INVENTION

The present invention discloses a system, a method, and an apparatus for providing access number status information using an automated voice response system or interactive voice response system (IVR). The IVR can also provide callers with access numbers local to the callers as alternative numbers to ones that the callers are experiencing problems with. The IVR can further allow callers to report problems with access numbers. Access number status information can be updated as changes to the access number status are reported by users, system administrators, or automated routines.

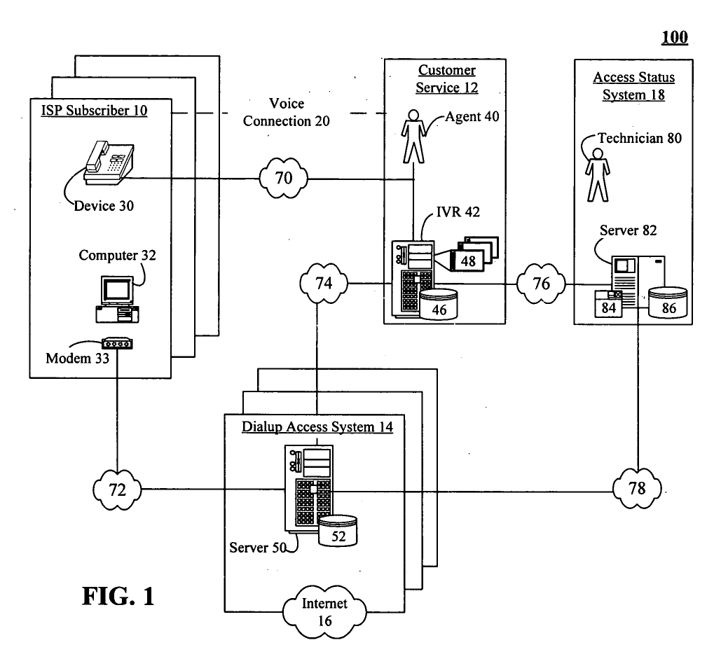

FIG. 1 is a schematic diagram illustrating an automated system 100 for automatically presenting dialup access number status information in accordance with one embodiment of the invention. The system 100 can include ISP subscribers 10, a customer service center 12, an access status system 18, and a dialup access system 14.

The dialup access system 14 can grant Internet 16 access to the ISP subscribers 10. Typically a computer 32 attached to a modem 33 will communicatively link to a server 50 across network 72. The server 50 will provide one or more ports to the Internet 16 that are associated with one or more dialup access numbers. The dialup access number can determine the port though which the ISP subscriber 10 is connected to the Internet 16. Dialup account information contained in data store 52 can be used authorized the ISP subscriber 10.

The customer service center 12 can receive ISP subscriber 10 calls pertaining to dialup services and can help the ISP subscriber 10 establish dial-up service. For example, the customer service center 12 can provide the ISP Subscriber 10 with a status of a dialup number responsive to an inquiry about the number's status.

Support functions of the customer service center 12 can be handled using one or more live agents 40 and/or an Interactive Voice Response system 42. The live agents 40 and the IVR 42 can utilize data supplied by data store 46 when interacting with an ISP subscriber 10. Data store 46 can include customer specific data, network specific data, service specific data, historical data, or the like. Interface 48 can be designed to provide the agent 40 with the necessary customer specific information to intelligently interact with the ISP Subscriber 10 and to record interaction specifics. For example, when the ISP Subscriber 10 is transferred to agent 40 by the IVR 42, information provided to IVR 42 can be made available to the agent 40 using interface 48.

As mentioned, one function of the customer service center 12 is to provide the ISP subscriber 10 with access number status information. Towards this end, the IVR 42 can request and receive status information to and from the access status system 18.

The access status system 18 can include a server 82 that determines the present status of access numbers. In one embodiment, a series of codes can be used to indicate an access number's status. These codes can be associated with configurable messages, which can be presented to the ISP Subscriber 10. Status information and status codes used by the server 82 can be stored in data store 86. Technician 80 can use interface 84 to monitor the server 82 and adjust data within data store 86.

The customer service center 12 and the access status system 18 can be linked to the dialup access center 14 through network 74 and network 78. Information in data store 46, 86, and 52 can be shared across these links. Additionally, Once the ISP Subscriber 10 is connected to the Dial Access System 14, client based routines and data within computer 32 can be accessed by the IVR 42, server 82, and server 50 across network 72, 74, 78, and 76 as needed assuming proper authorization is provided.

As used herein, voice link 20 can be a standard public switched telephone network (PSTN) connection, which is typically a circuit-switched connection. The voice link 20 is not limited in this regard, however, and a packet-based connection that utilizes a technology like Voice over Internet Protocol (VoIP) can also form the voice link 20.

Networks 70, 72, 74, 76, 78, and 16 can be implemented as any of a variety of fashions so long as content is conveyed using encoded electromagnetic signals. Further, any of a variety of communication devices, such as customer premise equipment (CPE), computers, modems, routers, switches, or the like, can be included within networks 70, 72, 74, 76, 78, and 16.

Each of the networks 70, 72, 74, 76, 78, and 16 can convey content in a packet-based or circuit-based manner. Additionally, each of the networks 70, 72, 74, 76, 78, and 16 can convey content via landlines or wireless data communication methods. For example, each of the networks 70, 72, 74, 76, 78, and 16 can separately include an Intranet, a local area network, a wide area network, or a combination thereof. In another example, each of the networks 70, 72, 74, 76, 78, and 16 can include a telephony network, like a mobile wireless network or a public switched telephone network (PSTN).

The data stores 46, 52, and 86 can store information in any recording medium, such as a magnetic disk, an optical disk, a semiconductor memory, or the like. Further, each of the data stores 46, 52, and 86 can utilize any information retention technique including a file-based storage technique or a database storage technique. Moreover, each of the data stores 46, 52, and 86 can be a storage area fixed to a geographical location or a storage area distributed across a network space.

It should be appreciated that the arrangements shown in FIG. 1 are for illustrative purposes only and that the invention is not limited in this regard. The functionality attributable to the various components can be combined or separated in different manners than those illustrated herein. For instance, the access status system 18 can be integrated with the customer service center 12 in one embodiment of the invention disclosed herein.

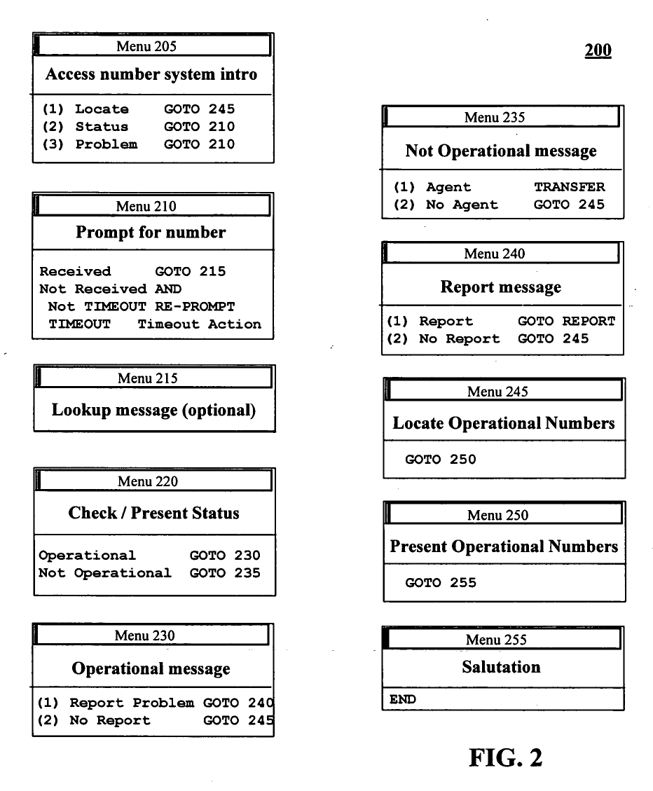

FIG. 2 is a menu structure 200 for providing dialup access number status information in accordance with one embodiment of the invention. The menu structure 200 can be utilized in the context of any of a variety of automated systems. For example, the menu structure 200 can be utilized by IVR 42 of system 100.

The menu structure 200 can begin with menu 205. Menu 205 can provide an introductory message. For example, the message can state “Thank you for calling. To obtain access numbers, Press 1. To check on the status of an access number, Press 2. To report connection problems or outages, Press 3.” Selecting menu option 1 can cause menu structure 200 to proceed to menu 245, where operational access numbers can be located and subsequently presented. Selecting either option 2 or 3 can cause menu structure 200 to proceed to menu 210. It should be noted, however, that the menu structure 200, as shown, assumes that option 2 was selected from menu 205.

In menu 210, a prompt for an access number can be presented. For example, the prompt can state “Please enter the access number you are experiencing problems with now, beginning with the area code.” When an access number is correctly received, the menu structure 200 can proceed to menu 215.

Otherwise, the menu structure 200 can re-prompt for an access number that causes the menu structure 200 to loop back to menu 210. In one embodiment, each re-prompting can increment a prompt counter. Re-prompting or looping to menu 210 can occur until the prompt counter is greater than a previously established timeout threshold, at which time a timeout action can occur. For example, the timeout threshold can be set to the number three so that after three prompts, a timeout action can occur instead of the menu structure 200 looping back to menu 210.

The timeout action can result in the execution of an alternative programmatic action or script designed to release the menu structure 200 from continuously looping at menu 210. For example, in one embodiment, the timeout action can result in a disconnection event. In another example, the timeout action can establish a connection between a caller and a live agent. In yet another example, the timeout action can cause menu 210 to proceed to a help menu.

In menu 215, a lookup message can be provided. For example, the lookup message can state, “We are currently checking upon the access number entered, please wait.” In one embodiment, menu 215 can be skipped if an estimated wait time for processing the received access number is low, such as under one second. The threshold for determining if a wait time is low can be a configurable value.

In another embodiment, one or more user-selected options can be added to menu 215 if an estimated wait time for processing the received access number is high, such as over ten seconds, where the value of “ten seconds” can be a configurable value. When the wait time is high, for example, the lookup message can state, “While you are waiting, would you like to be presented with alternative access numbers in your area? If so, press 1. If not, press 2.” When option 1 is selected, the structure can proceed to menu 245. When option 2 is selected, the structure can proceed to menu 220.

In menu 220, the status for the received access number can be determined. When status indicates the number is operational, the structure can proceed to menu 230. When the status indicates the number is not operational, the structure can proceed to menu 235.

In menu 230, an operational message can be presented. The operational message can state, for example, “Access number XXX-XXX-XXXX has been listed as online and operational. If you are experiencing connection problems with this number, either there has been a recent outage not yet detected, or your personal equipment is setup incorrectly or is malfunctioning. If you believe that there has been a recent outage, which you would like to report, press 1. Otherwise, press 2 to proceed.” When option 1 is selected, the structure can proceed to menu 240. When option 2 is selected, the structure can proceed to menu 245. It should be appreciated, that other options (not shown) can be provided by menu 230. For example, options can be included to be transferred to technical support, to be transferred to an equipment setup checklist, to hear alternative numbers, etc.

In menu 235, a not operational message can be presented, such as “Access number XXX-XXX-XXXX has been listed as experiencing problems. These problems are currently being investigated and corrected by technical support staff. Please temporarily utilize an alternative access number. Please press 1 if you would like to speak with a live agent. Otherwise, press 2 to proceed.” Selection of option 1 can transfer the caller to an agent. Selection of option 2 can result in the structure proceeding to menu 245.

In menu 240, a report message can be presented, such as “If you are experiencing problems with this access number, please let us know by answering the following questions using the keypad on your phone. Our Network Operations Center will receive your report immediately. This will take about one minute, and we will check for alternative access numbers in your area during this time. Please press 1 if you would like to report a problem. Otherwise, press 2.” Selection of option 1 can transfer the caller to a problem reporting menu. Selection of option 2 can result in the structure proceeding to menu 245.

In menu 245, one or more access numbers that are operational can be located, where the located access numbers can be within the same local telephone area as the received access number. When no access number was explicitly received responsive to menu 210, a “received” access number can be automatically generated from caller identification information. In one embodiment, the received access number can be excluded from the set of numbers located by menu 245. The menu structure 200 can proceed from menu 245 to menu 250.

In menu 250, located operational numbers can be presented. For example, the presentation of alternative numbers can state, “There are [number] other Access Numbers in the area you are calling from which are listed as online and operational. These shall now be listed in order. Press (*) to stop this listing.” After operational numbers have been presented, the structure can proceed to menu 255.

It should be noted that steps 245 and steps 250 can function interactively so as to minimize user-perceived delays in locating/presenting operational numbers. For example, a first located operational number can be presented to the user while menu 245 was looking up a second, third, forth, or nth access number. By the time the user has been presented with the first operational number, a second operational number can be located which can be presented to the user in turn.

The ability to check and read access numbers at the same time can be particularly advantageous in embodiments where locating operational access numbers is a time consuming task. For example, in one embodiment, a list of all access numbers can be initially referenced, each number can be checked to determine the operational status of the number, and only those numbers with a status of operational can be presented to a user.

In menu 255, a salutation message can be presented and menu structure 200 can end. The salutation message, for example, can state “Thank you for using the automated system. You may now hang up. Good bye.”

To this point, options (1) and (3) from menu 205 have been largely ignored. It should be noted that these options have been included to illustrate that, the menu structure 200 can be integrated within other caller services, such as an access number locator (option 1) and a problem reporting system (option 3). These services can utilize many of the same components as those needed by the system that provides the access number status information, as shown by menu structure 200. For example, each of these services present operational numbers to the caller as alternative access numbers to a received access number (menu 250).

Further, in one embodiment of the present invention, each of these services can represent modules within a modularized software system. Consequently, data can be shared among different modules (hence used commonly by different services), thereby reducing development and maintenance costs. Additionally, use of a common menu structure 200 by different services can create a common “look and feel” for customers, thereby minimizing customer confusion for those customers familiar with other services provided by the modularized software system.

It should also be noted that the menu structure 200 can be a destination point from a remote menu structure, such as structures represented by options (1) and (2). That is, the menu structure 200 can represent a branching point to which a caller is directed upon selecting an option from the remote menu structure. Further, when used a destination point, data flow can return to the calling menu structure, once programmatic actions dependant upon menu structure 200 are completed. In such a situation, the ending option of menu 255 can branch control to the calling menu structure instead of terminating the telephony connection, and the salutation message can indicate a message such as “caller is being transferred to XXX, please wait.”

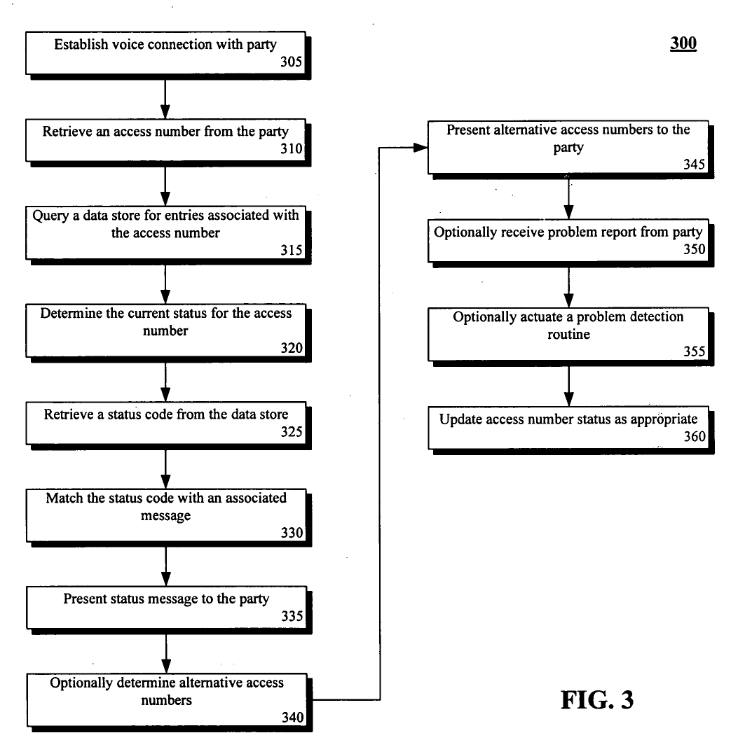

FIG. 3 is a flow chart illustrating a method 300 for providing dialup access number status information in accordance with one embodiment of the invention. The method 300 can be performed in the context of any of a variety of automated systems capable of providing users or calling parties with dialup access number status information. For example, the method 300 can be performed in the context of system 100 of FIG. 1. In another example, the method 300 can be performed by an automated voice response system that utilizes a menu structure similar to structure 200 of FIG. 2.

The method 300 can begin in step 305, where a voice connection can be established between an automated voice response system, like an IVR, and a calling party. In step 310, an access number can be retrieved from the party. In step 315, a data store can be queried for entries associated with the access number input by the party. In one embodiment, the data store can be remotely located from the automated voice response system.

In step 320, the current status for the access number can be retrieved from the data store. In one embodiment, shown in step 325, the data store can indicate the status by a status code, which can be retrieved in step 325.

In step 330, the status code can be matched with an associated message. In a specific embodiment, the matching of status codes to messages can occur within the automated voice response system, even if the status codes are retrieved from a remote data store. In such an embodiment, the messages associated with the status codes can be configured by an administrator of the automated voice response system.

In embodiments that do not rely upon status codes, such as an embodiment where status messages are contained within the data store, the method can skip steps 325 and 330 and proceed directly to step 335.

In step 335, a status message can be presented to the party via the voice connection. The status of access numbers can be constantly updated, as shown in step 360, which results in corresponding updates occurring within the data store. Consequently, the method 300 can provide up-to-date status information in a dynamic environment where access number status information can be constantly changing.

Method 300 can also include a number of optional steps (steps 340-355) that can be implemented by an automatic voice response system. One option (steps 340 and 345) is to present the party with alternative access numbers within the same service region as the party provided access number. That is, in step 340, alternative numbers can be determined and in step 345 the numbers can be presented to the party.

In another option, shown by step 350, the party can be prompted to report a problem with an access number listed in the data store as operational. This report can cause the status of a number listed in the data store to change.

In step 355, a problem detection routine can be actuated by the automated voice response system. For example, the automated voice response system can interrogate hardware within an ISP's network, such as an access port associated with the access number provided by the party, to determine whether the hardware is operational. When the status indicated in the data store and the status returned by the problem detection routine do not match, the data store can be updated.

Options listed for method 300 can be beneficially combined in some situations. For example, the status within the data store may not be immediately updated responsive to a party reported problem (step 350) unless the reported problem is confirmed by a problem detection routine (step 355).

It should be appreciated that the steps detailed within method 300 represent one illustrative embodiment of the inventive arrangements disclosed herein. The scope of the invention is to be construed as including adaptive deviations of the method 300 that are essentially the same as steps detailed herein.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for an automated voice response system to present access numbers status information to dial-up Internet users, the automated voice response system performing the steps of:
establishing a telephony communication with a party responsive to a received telephone call from the party;
receiving from the party an access number;
querying at least one data store for entries associated the access number;
responsive to the querying step, determining a current status for the access number; and
presenting an indication of the status to the party across the telephone communication.

2. The method of claim 1, wherein the data store is remotely located from the automated voice response system.

3. The method of claim 1, wherein the status signifies that no problem with the access number exists, the automated voice response system further performing the step of:
prompting the party to report a problem with the access number.

4. The method of claim 3, the automated voice response system further performing the step of:
responsive to receiving a problem report from the party, automatically updating the status of the access number within the data store to indicate a problem exists with the access number.

5. The method of claim 3, the automated voice response system further performing the steps of:
actuating a problem detection routine configured to determine whether a network problem exists with an access port associated with the access number; and
when the detection routine indicates no problem exists, presenting a detection result message to the party across the telephone communication, the detection result message conveying at least one of a message that indicates that the access number is operational and a message that indicates the party is experiencing a problem with party controlled equipment.

6. The method of claim 1, wherein when at least one of the status for the access number and party submitted input indicates that a problem with the access number exists, the automated voice response system further performing the step of:
presenting the party with at least one different access number within a same service region as the access number.

7. The method of claim 1, wherein the querying step results in the automated voice response system receiving a status code, the automated voice response system further performing the steps of:
matching the status code with a message associated with the status code; and
wherein the indication includes the message associated with the status code.

8. The method of claim 7, wherein the message associated with the status code is administratively configurable by an administrator of the automated voice response system.

9. A machine-readable storage having stored thereon, a computer program having a plurality of code sections, said code sections executable by a machine for causing the machine to perform the steps of:
establishing a telephony communication with a party responsive to a received telephone call from the party;
receiving from the party an access number;
querying at least one data store for entries associated the access number;
responsive to the querying step, determining a current status for the access number; and
presenting an indication of the status to the party across the telephone communication.

10. The machine-readable storage of claim 9, wherein the data store is remotely located from the machine.

11. The machine-readable storage of claim 9, wherein the status signifies that no problem with the access number exists, the machine further performing the step of:
prompting the party to report a problem with the access number.

12. The machine-readable storage of claim 11, the machine further performing the step of:
responsive to receiving a problem report from the party, automatically updating the status of the access number within the data store to indicate a problem exists with the access number.

13. The machine-readable storage of claim 11, the machine further performing the steps of:
actuating a problem detection routine configured to determine whether a network problem exists with an access port associated with the access number; and
when the detection routine indicates no problem exists, presenting a detection result message to the party across the telephone communication, the detection result message conveying at least one of a message that indicates that the access number is operational and a message that indicates the party is experiencing a problem with party controlled equipment.

14. The machine-readable storage of claim 9, wherein when at least one of the status for the access number and party submitted input indicates that a problem with the access number exists, the machine further performing the step of:
presenting the party with at least one different access number within a same service region as the access number.

15. The machine-readable storage of claim 9, wherein the querying step results in the machine receiving a status code, the machine further performing the steps of:
matching the status code with a message associated with the status code; and
wherein the indication includes the message associated with the status code.

16. The machine-readable storage of claim 15, wherein the message associated with the status code is administratively configurable by an administrator of the machine.

17. An system for providing dialup access number status comprising:
an interactive voice response system for interfacing with at least one ISP subscriber over a voice connection;
a dialup access system configured to provide the at least one ISP subscriber with access number information, said access number information being associated with dial-up Internet access relating to said ISP subscriber, wherein the interactive voice response system is a customer service component supporting the dialup access system.
an access status system configured to provide the interactive voice response system with status data relating to the at least one dialup access number.

18. The system of claim 17, further comprising:
an interactive voice response system configured to prompt the at least one ISP subscriber to report user perceived problems with a selected one of the at least one access number whenever the access status system indicates that the status of the selected one signifies that the access number is operational.

19. The system of claim 17, further comprising:
an interactive voice response system configured to present selected ones of the at least one access number to the at least one ISP subscriber, where the selected ones are access numbers local to the at least one ISP subscriber.

20. The system of claim 17, the dialup access system further comprising:
a server configured to detect problems with at least one access ports associated with the at least one dialup access numbers and to convey detected problems to the access status system.
